(19) United States
(12) Patent Application Publication
(10) Pub. No.: US 2010/0323318 A1
(43) Pub. Date: Dec. 23, 2010

(54) Laser Handpiece

(75) Inventors: Ursula Schmitt, Assmannshardt (DE); Thomas Jaeggle, Hochdorf (DE); Bernd Liebermann, Berg (DE); Emanuel Von, Kienlin (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Kaltenbach & Voigt GmbH, Biberach (DE)

(21) Appl. No.: 12/521,683

(22) PCT Filed: Dec. 13, 2007
(86) PCT No.: PCT/EP2007/010973

§ 371 Date: Aug. 10, 2009

(30) Foreign Application Priority Data
Dec. 29, 2006 (DE) 10 2006 062 063.1

(51) Int. Cl. A61C 1/00

(52) U.S. Cl. 433/29

(57) ABSTRACT

A laser handpiece, which has an outer guide sleeve in which a light guide is contained, is provided with a releasable clamping device. By the rotation of a rotary ring on the guide sleeve, the clamping device can be released and an advancing of the light guide, either manually or automatically, can be guaranteed.

The invention relates to a laser handpiece, in particular for dental applications, having an outer guide sleeve, having a light guide that extends through the guide sleeve and whose rear end can be connected to a laser light source and whose front end protrudes from the guide sleeve and is intended to deliver the laser light, and having a releasable clamping device which arrests the light guide in a clamped position with respect to the guide sleeve and which in a non-clamped position permits a displacement of the light guide in the guide sleeve.

Such a laser handpiece is known from U.S. Pat. No. 5,228,852. In the case of this laser handpiece the clamping device is realized in that the guide sleeve at its rear end is provided with a clamping gap which can be compressed by screwing on a closing cap. If the end of the light guide protruding from the guide sleeve at the front is worn away as a result of the laser processing, the clamping sleeve at the rear end of the guide sleeve is released and the light guide protruding out of the clamping sleeve at the rear is pushed forwards by hand so that the end of the light guide standing out from the guide sleeve at the front has the necessary working length again.

The laser handpiece in accordance with the invention differs from that in accordance with the prior art in that the clamping device is longitudinally displaceable for the purposes of transferring from the clamped position into the non-clamped position.

As a result of the last-mentioned feature of the invention, the possibility is opened up of configuring the follow-up guidance of the light guide in a more simple and more rapid manner.

A first version for the realization of this advantage in which the advance of the light guide is still effected by hand can be that the clamping device contains a hollow collet chuck which is arranged in a longitudinally displaceable manner in the guide sleeve and through which the light guide is guided. The longitudinal displacement can be brought about in such a case in that provided on the clamping device there is a rotary ring whose rotational movement is converted into a movement of longitudinal displacement for the collet chuck by means of a connecting-link-guiding element that is further provided.

A second version of the possibility opened up by the feature of the invention in which the advance is effected automatically with the longitudinal movement of the clamping device can be that arranged on the outwardly conically formed collet head there is a clamping ring which holds the collet chuck, which is under spring tension, in the clamped position as long as it (the ring) is located in a forward position on the collet head and which allows the collet chuck to be opened when it (the ring) strikes against a stop during the movement of longitudinal displacement of the collet chuck and is forced back into a rear position on the collet head that is moving forwards.

Exemplary embodiments of the invention are described in the following with reference to the drawings, in which:

FIGS. 1 to 9 show the first version of the laser handpiece; and

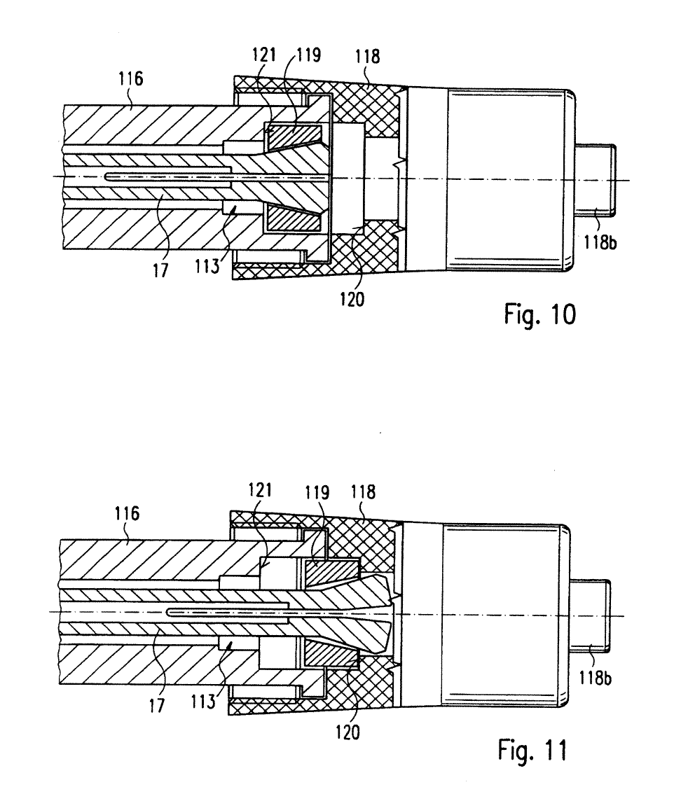

FIGS. 10 and 11 show the variations that are necessary to realize the second version of the laser handpiece.

The laser handpiece shown in FIG. 1 has a guide sleeve 1 with a front closing cap 18 and a rear closing cap 5. A rotary ring 4 is arranged on the guide sleeve 1 in front of the rear closing cap 5. A cannula-carrier body 2 with a cannula 3 sits on the front closing cap. The rear closing cap 5 is provided with a small guide tube 6. Extending through the laser handpiece there is a sheathed light guide 7 from which the non-sheathed core 7a (which can consist of a plurality of light-guiding fibers) protrudes. The rear end of the light guide 7 normally shows out of the small guide tube 6, although it is not represented here. This rear end of the light guide 7 is connected to a laser light source—also not represented.

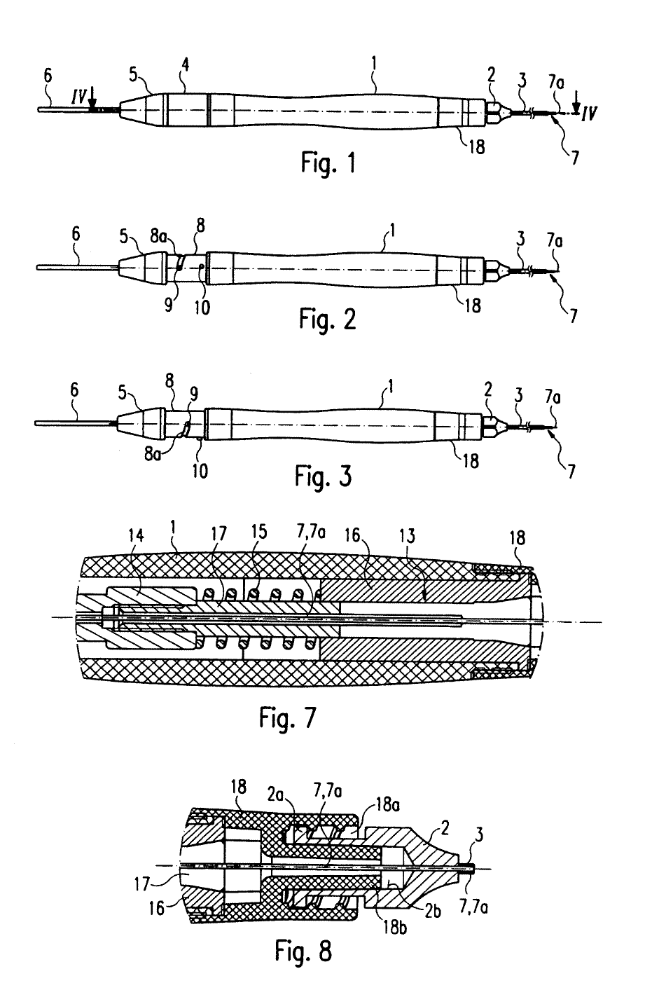

The laser handpiece shown in FIG. 2 differs from that in FIG. 1 only in that the rotary ring 4 has been omitted. As a result, a connecting-link-guiding element 8 that is also annular and is provided with an oblique connecting-link groove 8a is visible. A guide pin 9, whose function will be explained further later, runs in the connecting-link groove 8a. Furthermore, the connecting-link-guiding element 8 bears a carrier pin 10 which, as will be explained further later, guarantees a rotational connection with the rotary ring 4 so that in the event of rotation of the rotary ring 4 with respect to the guide sleeve 1 the connecting-link-guiding element 8 is entrained in rotation.

FIG. 3 is a representation which shows the laser handpiece shown in FIG. 2 in a position rotated about 90°.

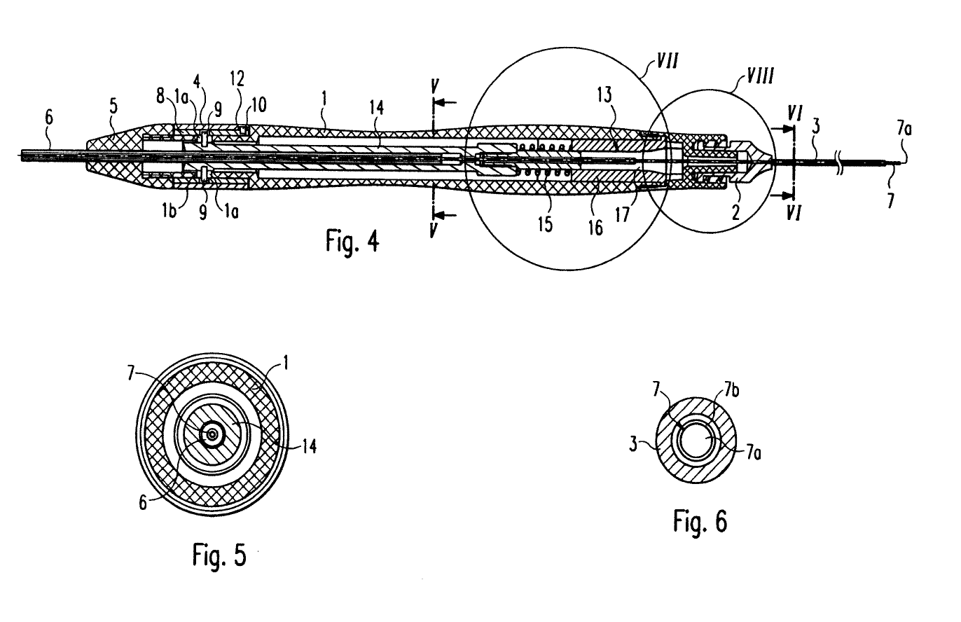

FIG. 4 shows a section IV-IV through FIG. 1. It can be seen that the rotary ring 4 is rotatably arranged on the rear portion of the guide sleeve 1. The connecting-link-guiding element 8 is located underneath the rotary ring 4. The rear end of the guide sleeve 1 extends through the interior of the connecting-link-guiding element 8. It has two diametrically opposed longitudinal slots 1a through which the two guide pins 9 extend. The guide pins 9 sit at the rear end of a hollow displacement rod 14 which extends through the interior of the guide sleeve. It can further be seen that the carrier pin 10 is anchored in the connecting-link-guiding element 8 and extends outwards. With its outer end it engages in a recess 12 which is located on the inside of the rotary ring 4.

It can further be inferred from FIG. 4 that the front end of the displacement rod 14 has a widened diameter and also a central bore into which the rear end of a collet chuck 17 is inserted. The front part of the collet chuck 17 is mounted in a displaceable manner in a cylindrical insert portion 16 which is pushed into the guide sleeve 1. A helical spring 15 which is arranged between the cylindrical insert portion 16 and the thickened front end of the displacement rod 14 is under compressive stress and attempts to press the displacement rod 14 backwards with the collet chuck 17. The collet chuck 17, the cylindrical insert portion 16 and the displacement rod 14 together form a clamping device 13 whose function is explained further in the following.

The further details that can be seen in FIG. 4 are explained in the following with reference to FIGS. 5 to 8.

FIG. 5 is a cross section V-V through FIG. 4. FIG. 6 is a section VI-VI through FIG. 4. FIG. 7 is an enlarged partial representation VII from FIG. 4. FIG. 8 is an enlarged partial representation VIII from FIG. 4.

FIG. 5 shows the concentric arrangement of the light guide 7, the small guide tube 6, the displacement rod 14 and the guide sleeve 1.

FIG. 6 shows in particular that the light guide 7 consists of a light-guiding core 7a and a sheathing 7b. The light guide 7 runs through the cannula 3 which is the continuation of the cannula-carrier head 2.

FIG. 7 shows that in the case of a forward movement of the displacement rod 14 towards the right in opposition to the force of the spiral coiled spring 15 the collet chuck 17 is entrained and is likewise displaced to the right. As a result, the collet chuck emerges from the cylindrical insert portion 16. The collet chuck at its front end is provided with a longitudinal slot (not visible here) that divides the collet chuck into two portions that are under spring tension and are joined together at their rear end. The two front portions of the collet chuck open when the collet chuck 17 is displaced to the right and emerges from the cylindrical insert portion 16. A light guide 7 that extends through the displacement rod 14 and the collet chuck 17 is secured against longitudinal displacement with respect to the guide sleeve 1 when the collet chuck 17 is located in the clamped position shown in FIG. 7. By rotating the clamping ring 4, the clamping device 13 can be transferred from the clamping position into the non-clamping position. This is effected by displacing the displacement rod 14 with the collet chuck 17 to the right with the result that the two front portions of the collet chuck 17 open, whereby the clamping effect is removed from the light guide 7. When the rotary ring 4 is released again, the spiral coiled spring 15 causes the displacement rod 14 and the collet chuck held by the latter to be pushed back with the result that the light guide 7 is again firmly clamped. In order to push the light guide 7 forwards by hand, the clamping device 13 must first be opened and then the portion of the light guide (not represented) that shows out of the small guide tube 6 must be grasped by the hand and pushed forwards.

FIG. 8 shows how the cannula-carrier head 2 is secured on the front closing cap 18. The front closing cap 18 has for this purpose at its front end a conical cylinder peg 18b and also an internal thread 18a surrounding the latter. The cannula-carrier head 2 has at its rear end a hollowly cylindrical extension with a laterally projecting flange 2a that engages into the internal thread 18a and attains therewith a screw action. The hollow-cylindrical extension at the rear end of the cannula-carrier head 2 is, for its part, likewise inwardly conical and therefore when screwed on is applied tightly against the conical peg 18b. This is a conical connection which is standardized and goes by the name of a Luer lock (DIN EN 1707). Such a Luer lock connection is also described, for example, in U.S. Pat. No. 5,378,147.

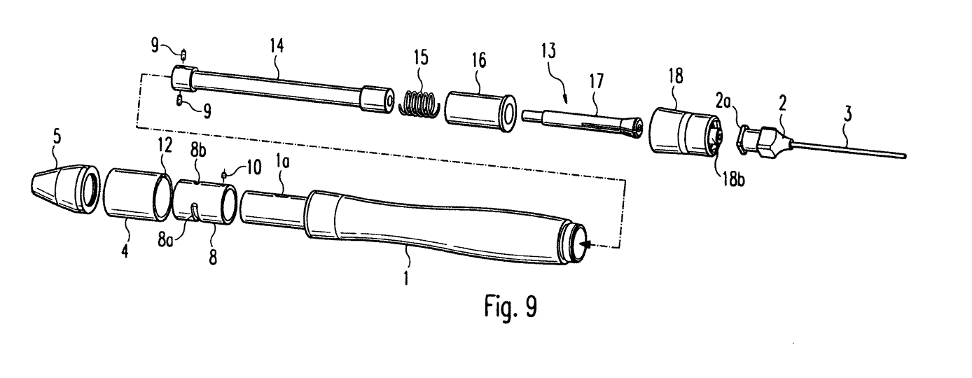

FIG. 9 shows all of the portions previously described in an exploded view.

While in the case of the version shown in FIGS. 1 to 9 the displacement of the light guide has to be effected by hand, the version according to FIGS. 10 and 11 shows how an automatic advance of the light guide 7 is achieved by means of slight changes in the design. FIGS. 10 and 11 are modelled on FIG. 8. They show the modified front closing cap 118 and the modified cylindrical insert portion 16. The cannula-carrier head is omitted. The chronic peg 118b, visible here therefore, emerges from the front closing cap 118.

For a better understanding, the representation in FIGS. 10 and 11 is rotated a further 90° in relation to that in FIG. 8 so that the separation of the two front portions of the unchanged collet chuck 17 in the non-chucking position of the clamping device denoted here by 113 is visible. Moreover, the longitudinal slot that divides the front portion of the collet chuck 17 into two halves acting as chuck jaws can be seen.

In the second version in accordance with FIGS. 10 and 11, in comparison with the first version what is new above all is that arranged on the conical front end of the collet chuck 17 there is a clamping ring 119 which has a corresponding inner cone. This clamping ring in the chucking position shown in FIG. 10 is pressed by means of a shoulder 121 provided on the cylindrical insert portion 116 onto the front end of the collet chuck 17 and holds the two portions of the collet chuck closed. If the collet chuck 17 is now moved to the right as a result of rotation of the rotary ring 4, the clamping ring 119 sitting with frictional flow on the front conical portion of the collet chuck 17 is moved with the collet chuck to the right until it strikes against a stop 120 provided on the front closing cap 118. With further movement of the collet chuck 17 to the right, the clamping ring 119 is prevented from moving therewith and slides down from the front conical portion of the collet chuck 17 in a corresponding manner. As a result, the collet chuck can be opened. This is shown in FIG. 11.

As in the first version, the light guide is entrained to the right in the case of the movement of the collet chuck 17 and when the jaws of the collet chuck are released is freed in this position. What is crucial, however, is that it is no longer taken back with it, but the collet chuck in the case of the backward movement remain open for so long until it dips into the inner cone of the clamping ring 119 again. In this way therefore, automatic forward transportation of the light guide is guaranteed.

In order to guarantee that the light guide is also not taken back again with the collet chuck as a result of frictional flow, even if the latter is open, it can be advantageous to dimension the cannula 3 on the cannula-carrier head 2 in such a way that the frictional flow between the light guide 7 and the inner wall of the cannula 3 is greater than the frictional flow between the collet chuck 17, or the displacement rod 14, and the light guide 7.

1. A laser handpiece comprising:
an outer guide sleeve having a light guide that extends through the guide sleeve, the light guide having a rear end that can be connected to a laser light source and a front end that protrudes from the guide sleeve the laser light, and
a releasable clamping device which that arrests with the light guide in a clamped position with respect to the guide sleeve and that in a non-clamped position permits a displacement of the light guide in the guide sleeve,
wherein
the clamping device is longitudinally displaceable for the purpose of transferring from the clamped position into the non-clamped position.

2. A laser handpiece according to claim 1,
wherein
the clamping device contains a hollow collet chuck that is longitudinally displaceable in the guide sleeve.

3. A laser handpiece according to claim 2, comprising,
provided on the clamping device, a rotary ring whose rotational movement is converted into a movement of longitudinal displacement for the collet chuck by a connecting-link-guiding element.

4. A laser handpiece according to, claim 2, comprising,
arranged on the outwardly conically formed collet head of the collet chuck, a clamping ring that holds the collet chuck, which is under spring tension, in the clamped position as long as the ring is located in a forward position on the collet head and allows the collet chuck to be opened when the ring strikes against a stop during the movement of longitudinal displacement of the collet chuck and is forced back into a rear position on the collet head that is moving forwardly.
